(19) United States
(12) Patent Application Publication
(10) Pub. No.: US 2001/0019471 A1
(43) Pub. Date: Sep. 6, 2001

(54) Surge arrester

(76) Inventors: Bernhard Richter, Wettingen (CH); Stephan Hoffarth, Baden (CH); Michael Hagemeister, Zurich (CH)

Correspondence Address: BURNS DOANE SWECKER & MATHIS L L P, POST OFFICE BOX 1404, ALEXANDRIA, VA, 22313-1404, US

(21) Appl. No.: 09/756,912

(22) Filed: Jan. 10, 2001

(30) Foreign Application Priority Data
Jan. 10, 2000 (DE) 100 00 617.5

(51) Int. Cl. H02H 1/00

(52) U.S. Cl. 361/117; 361/127

(57) ABSTRACT

The surge arrester has an arrester housing, two electrical power connections (16, 17) which are routed out of the arrester housing, and at least one varistor, which is arranged in the arrester housing (1, 2), is in the form of a disc and has two contact points which are provided on the end faces. The contact points are each electrically conductively connected to one of the two electrical power connections (16, 17).

The varistor contains a non-metallized active part (12) and two elastic contact elements (11, 13) which are pressed against the end faces of the active part (12), forming an electrical contact. The end surfaces (12a, 12b) may be convex or concave instead of being plane-parallel and, if they are in the desired plane-parallel form, form a small angle with respect to one another. The elastic contact elements (11, 13) and the non-metallized end surfaces (12a, 12b) allow good electrical contact in all cases. Since, during manufacture of the active part, the geometric tolerance limits can be kept relatively wide, the surge arrester can be produced extremely cost-effectively.

The invention is based on a surge arrester as claimed in the preamble of patent claim 1.

The preamble of patent claim 1 of the invention refers to a prior art as is known from DE 19545505 C1. In the case of the surge arrester described there, for low-voltage systems, a varistor is thermally conductively connected to a thermal disconnection device comprising a fuse strip and a thermal release with a eutectic fuse alloy, and this results in the thermal release being disconnected, and a damage indicator being initiated by spring force, if the varistor is unacceptably heated. In this case, the fuse strip, which is resistant to surge currents, is arranged with weak points within a fuse housing and melts in the event of a release, overcoming the fastening of the damage indicator within the fuse housing. The thermal release, which is arranged outside the fuse housing, comprises an identifying signaling wire which keeps the damage indicator in the “no indication” position and is broken when the fuse strip melts, or is melted by the short-circuit current. This surge arrester is relatively complex to produce.

The invention, as it is defined in patent claim 1, achieves the object of specifying a surge arrester of the type mentioned initially which can be produced easily and cost-effectively and is nevertheless distinguished by excellent operating characteristics.

In the surge arrester according to the invention, the varistor contains a non-metallized active part and two elastic contact elements, which are pressed against the end faces of the active part, forming an electrical contact and are preferably formed from graphite. These measures result in good electrical power transfer with a largely uniform current density from the active part to the rigid contact elements which produce the contact pressure, and these contact elements are electrically conductively connected to the electrical power connections of the surge arrester. Even if the end surfaces of the active part are not completely planar with respect to one another, but, possibly, are slightly curved in the concave or convex sense or are inclined at a small angle to one another, an excellent operating behavior is thus always achieved.

For certain embodiments of the surge arrester, it is sufficient for the active part not to be passivated at the edge.

A surge arrester having good long-term stability is obtained if the active part of the varistor is passivated at the edge, as can be achieved by the varistor having electrical insulation applied to its edge, said electrical insulation being composed of glass, epoxy varnish or a rubber or silicone ring drawn over the varistor edge. If the passivation has a ring and this ring is higher than the active part and/or the ring has an embossed profile, then it can also be used for positioning of the contact elements, which are designed to be elastic.

If the surge arrester according to the invention contains an electrical power interrupter which is in the form of a melting connection, and a damage indicating apparatus to which prestressing is applied when the electrical power interrupter is closed and which is visible once the electrical power interrupter is open, then it can be recommended that the melting connection be formed into an element of the electrical power interrupter which is in the form of a disc and is pressed against one of the two elastic contact elements of the varistor forming the contact force, since this then ensures good heat transfer from the varistor to the melting connection, and thus also reliable tripping of the electrical power interrupter.

Extremely cost-effective manufacture of a surge arrester according to the invention can be achieved if the arrester housing is predominantly axially symmetrical and has two housing parts which are connected to one another with a force fit forming the contact pressure and the prestress, in which an opening for the first electrical power connection and a part of the damage indicating apparatus which contains a signaling surface to pass through is formed in a first housing part, and an opening for the second electrical power connection to pass through is formed in a second housing part. During the manufacture of this arrester, only prefabricated parts, such as a connecting fitting or a component which contains this connecting fitting, a damage indicating apparatus and a prestressed electrical power interrupter, one of the electrical contact elements, the active part, a further one of the elastic contact elements, an electrical power transmission element which may be connected to this contact element, and a compression spring which produces a contact force are inserted into a predominantly tubular housing part, and the inserted parts are fixed, forming the contact force, by snapping them into a housing part which is in the form of a cap and contains a second connecting fitting.

The surge arrester formed in such a way can thus be manufactured very quickly and using extremely simple means, in particular even locally.

The invention will be explained in the following text with reference to exemplary embodiments. In the figures:

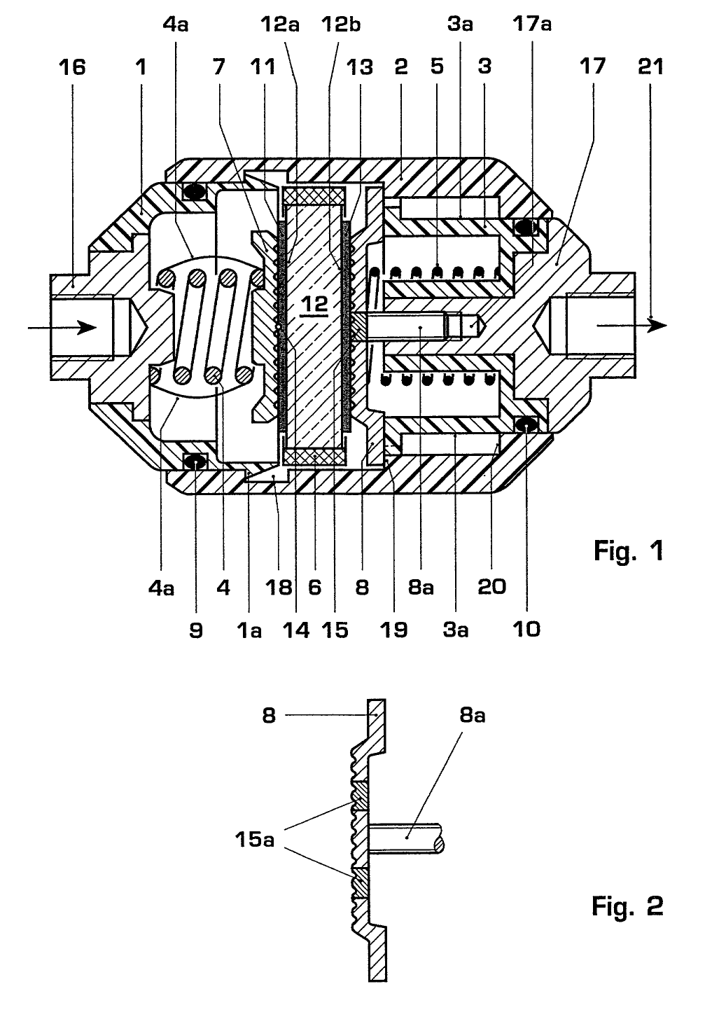

FIG. 1 shows a cross-sectional view of a surge arrester for low voltage with an electrical power interrupter having a thermal release in the form of a point, and

FIG. 2 shows an electrical power release with an annular thermal release for the surge arrester shown in FIG. 1.

In the figures, identical parts are identified by having the same reference symbols. FIG. 1 shows a cross section through a surge arrester having a arrester housing which is in two parts, is predominantly axially symmetrical and is composed of plastic, preferably such as a mechanically reinforced polyamide which is stabilized against photo-oxidation. Suitable reinforcement can be achieved by insertion of a filler, preferably in the form of glass spheres. An inner cutout 18 for a snap-action locking apparatus 1a of a housing part 1 (which is in the form of an insulating cap) to engage in is formed in a predominantly tubular housing part 2, and the housing part 1 is connected, in a watertight fashion, firstly firmly to a metallic electrical power connection 16 and, secondly, via a sealing ring 9, in the form of an O-ring, to the housing part 2. An electrical power transmission element 7, which is predominantly in the form of a disc, has an electrically conducive pressure connection to the electrical power connecting contact 16 via a metallic, electrically conductive compression spring 4. The compression spring 4 exerts a force, which can be preset and is, for example, 200 N, on the electrical power transmission element 7; in order to short-circuit its induction, it is bridged on the outside by flexible short-circuiting elements 4a composed of tinned copper.

An opposing bearing 19 in the housing part 2, which bearing is in the form of an inner annular shoulder, provides a rest, at the edge, for an electrical power transmission element 8, which is predominantly in the form of a disc, of an electrical power interrupter, which is firmly connected to an electrically conductive part of the electrical power interrupter, in the form of a threaded pin 8a, via a central point or circular-cylindrical melting connection 15, preferably silver solder, which melts at a temperature which can be preset but is in a typical temperature range of 140° C. to 300° C., preferably 180° C. The pen 8a is screwed into a threaded hole 17a in an electrical power connection 17, and is thus electrically connected to the latter. A fixed, integral, electrically conductive contact can also be provided (not illustrated) instead of this screw contact. The interior of the housing part 2 contains, between the electrical power interrupter and the electrical power connection 17, an electrically insulating, rotationally symmetrical damage indicating apparatus 3 having an external signaling surface 3a, preferably composed of a phosphorescent and/or fluorescent material, so that fault identification is clearly possible even in poor visibility conditions. When the surge arrester is in the operating state, this damage indicating apparatus firstly rests at the edge, by means of a flange, on the electrical power transmission element 8 of the electrical power interrupter; secondly it rests in a watertight manner via a sealing ring 10, which is in the form of an O-ring, on an end part of the housing part 2 and on the electrical power connecting contact 17. A compression spring 5, which produces a smaller stressing force than the compression spring 4, for example 50 N, is arranged in a cutout in the damage indicating apparatus 3. This compression spring is supported at one end on the damage indicating apparatus 3, and at the other end on the part 8 of the electrical power interrupter.

The electrical power transmission element 7 forms an electrically highly conductive pressure connection via a grooved surface and via an elastic contact element 13, which is preferably in the form of a graphite disc, with one end surface 12a of an active part 12, which is preferably in the form of a disc, of a varistor. The electrical power transmission element 8 has an electrically highly conductive pressure connection via a grooved surface and via an elastic contact element 13, which is likewise in the form of a graphite disc, with one end surface 12b of the active part 12. In this case, the compression spring 4 presses the active part of the varistor via the electrical power transmission element 7 against the opposing bearing 19 of the housing part 2. The grooved contact surfaces of the electrical power transmission elements 7, 8 result in force being transmitted uniformly to the elastic contact elements 11, 13, and in good heat transfer from the active part 12 to the electrical power transmission element 8 of the electrical power interrupter. In the center of its grooved surface, the transmission element 7 is firmly connected to the elastic contact element 11 by means of a droplet 14 of a fast-curing adhesive.

The active part 12, which is preferably composed of a metal oxide, in particular based on zinc oxide, is not metallized on its end surfaces 12a, 12b. At the edge, it is coated or covered with a dielectric passivation means, such as electrical insulation composed of glass or epoxy varnish or a ring 6, preferably composed of a dielectric elastomer, in particular such as silicone. The ring 6 is somewhat higher than the active part 12 of the varistor so that, at the same time, it forms a centering means for the elastic contact elements 11, 13 and the active part 12.

The surge arrester has a high impedance in the normal operating state. If dangerous overvoltages occur, for example caused by atmospheric discharges or by switching processes, the electrical resistance of the varistor falls as the electrical voltage rises, thus limiting this voltage. If the temperature of the varistor rises owing to overloading and the melting temperature of the melting connection 15 is reached in the process, then the melting connection opens. The compression spring 5 now presses the damage indicating apparatus 3 together with the electrical power connecting contact 17 in the direction of an arrow 21 to the right until the flange at the edge of the damage indicating apparatus 3, which was previously in contact with the part 8 of the electrical power interrupter, makes contact with a contact surface or an opposing bearing 20 on the housing part 2. In consequence, any undesirably high current is interrupted by the varistor, and the signaling surface 3a of the apparatus 3 is visible from outside the housing part 2 (not illustrated). This electrical power disconnection leads to a permanent, defined state, in which no free-forming connections and no consequential damage can occur after disconnection. The surge arrester can be installed in any desired orientation in an electrical system which is to be protected, although at least one of the two electrical power connecting contacts 16, 17 must be connected such that it is flexible.

FIG. 2 shows the electrical power transmission element 8 of the electrical power interrupter with a melting connection 15a arranged in a ring around its center rather than a point melting connection 15 as shown in FIG. 1. The electrical power interrupter equipped with this melting connection has the advantage that the electrical power disconnection can be adjusted more precisely, since the melting region 15a is not directly linked to the threaded pin 8a, which acts as a heat dissipator.

It is self-evident that the surge arrester may also be equipped with a number of varistors 12 (not illustrated). Instead of being plane-parallel, their end surfaces 12a, 12b may, for example, also be convex or concave (not illustrated). The elastic contact elements 11, 13 and the non-metallized end surfaces 12a, 12b each allow good electrical contact.

LIST OF REFERENCE SYMBOLS

| | |
|---|---|
| 1,2 | Housing parts |
| 1a | Snap-action locking apparatus |
| 3 | Damage indicating apparatus |
| 3a | Signaling surface |
| 4,5 | Compression springs |
| 4a | Short-circuiting elements |
| 6 | Ring |
| 7,8 | Electrical power transmission elements |
| 8a | Threaded pin |
| 9,10 | Sealing rings |
| 11,13 | Elastic contact elements |
| 12 | Active part |
| 12a,12b | End surfaces |
| 14 | Droplet |
| 15,15a | Melting connections |
| 16,17 | Electrical power connections |
| 17a | Threaded hole |
| 18 | Cutout |
| 19,20 | Opposing bearing |
| 21 | Arrow |

1. A surge arrester having an arrester housing, two electrical power connections (16, 17) which are routed out of the arrester housing, and at least one varistor which is arranged in the arrester housing, is in the form of a disc and has two contact points which are provided on the end faces and are each electrically conductively connected to one of the two electrical power connections (16, 17), characterized in that the varistor contains a non-metallized active part (12) and two elastic contact elements (11, 13) which are pressed against the end faces of the active part (12), forming an electrical contact.

2. The surge arrester as claimed in claim 1, characterized in that at least one of the two contact elements (11, 13) is a graphite disc.

3. The surge arrester as claimed in one of claims 1 or 2, characterized in that the active part (12) is not passivated.

4. The surge arrester as claimed in one of claims 1 or 2, characterized in that the active part (12) is passivated at the edge.

5. The surge arrester as claimed in claim 4, characterized in that the active part (12) has a ring (6) at the edge.

6. The surge arrester as claimed in claim 5, characterized in that the ring (6) is higher than the active part (12) in such a manner that it forms a boundary at the edge for positioning of the contact elements (11, 13).

7. The surge arrester as claimed in one of claims 5 or 6, characterized in that the ring (6) is formed by a dielectric elastomer, in particular a silicone.

8. The surge arrester as claimed in one of claims 1 to 7, having an electrical power interrupter, which is arranged in the electrical connection between a first (13) of the two contact elements (11, 13) and a first (17) of the two electrical power connections (16, 17) and is in the form of a melting connection, and having a damage indicating apparatus (3) to which prestressing is applied when the electrical power interrupter is closed and which is visible when the electrical power interrupter is open, characterized in that the melting connection (15, 15a) is formed into an element (8) of the electrical power interrupter which is in the form of a disc and is pressed against the first contact element (13) forming a contact force.

9. The surge arrester as claimed in claim 8, characterized in that the element (8) which is in the form of a disc has a grooved surface which is pressed against the contact surface (13).

10. The surge arrester as claimed in one of claims 8 or 9, characterized in that the melting connection (15, 15a) is in the form of a point or ring.

11. The surge arrester as claimed in one of claims 8 to 10, characterized in that the arrester housing is predominantly axially symmetrical and has two housing parts (1, 2) which are connected to one another with a force fit forming the contact pressure and the prestress, and in which an opening for the first electrical power connection (17) and a part of the damage indicating apparatus (3) which contains a signaling surface (3a) to pass through is formed in a first housing part (2), and an opening for the second electrical power connection (16) to pass through is formed in a second housing part (1).

12. The surge arrester as claimed in claim 11, characterized in that the two housing parts (11, 13) are snapped together.

13. The surge arrester as claimed in claim 12, characterized in that the prestressing is produced by a first compression spring (5) which is supported between the element (8) which is in the form of a disc, and the damage indicating apparatus (3), and the contact force is produced by means of a second compression spring (4) which acts on the second contact element (11).

14. The surge arrester as claimed in claim 13, characterized in that the second compression spring (4) is bridged by flexible short-circuiting elements (4a).

15. The surge arrester as claimed in one of claims 10 to 14, characterized in that the arrester housing is composed of a mechanically reinforced polyamide which is stabilized against photo-oxidation.
